(19) United States
(12) Patent Application Publication
(10) Pub. No.: US 2022/0330024 A1
(43) Pub. Date: Oct. 13, 2022

(54) THIRD PARTY REMOTE ACCESS POINT ON ENTERPRISE NETWORK

(71) Applicant: SAUDI ARABIAN OIL COMPANY, Dhahran (SA)

(72) Inventors: Mohammed S. Abuhaleegah, Ad Dammam (SA); Ali F. Al-Shaqaq, Sihat (SA); Ahmed S. Al-Ismail, Qatif (SA)

(73) Assignee: SAUDI ARABIAN OIL COMPANY, Dhahran (SA)

(21) Appl. No.: 17/226,137

(22) Filed: Apr. 9, 2021

(51) Int. Cl. H04W 12/088; H04W 12/06

(52) U.S. Cl. CPC H04W 12/088; H04W 12/06

(57) ABSTRACT

A method for network communication is disclosed. The method includes configuring a remote access point to have restricted access to an enterprise network, wherein the remote access point and the enterprise network are disposed in a first physical facility, the restricted access providing a guest Internet service to the remote access point, establishing, via the enterprise network and the Internet, a secure communication tunnel based on the restricted access to connect the remote access point and a remote network disposed in a second physical facility separate from the first physical facility, and transmitting, using the remote access point and through the secure communication tunnel, network communication data packets between a plurality of user devices disposed in the first physical facility and the remote network disposed in the second physical facility.

### BACKGROUND

Providing dedicated/leased network connectivity for a third party within a company enterprise network is very costly, time consuming, and difficult to construct over existing physical network. This would require installing and leasing dedicated links from the third party network in a remote facility to desired locations inside the company facility. Wireless communication services (e.g., Global System for Mobile (GSM) or Long Term Evolution (LTE)) are not always available or reliable for the third party within the company facility.

### SUMMARY

In general, in one aspect, the invention relates to a method for network communication. The method includes configuring a remote access point to have restricted access to an enterprise network, wherein the remote access point and the enterprise network are disposed in a first physical facility, the restricted access providing a guest Internet service to the remote access point, establishing, via the enterprise network and the Internet, a secure communication tunnel based on the restricted access to connect the remote access point and a remote network disposed in a second physical facility separate from the first physical facility, and transmitting, using the remote access point and through the secure communication tunnel, network communication data packets between a plurality of user devices disposed in the first physical facility and the remote network disposed in the second physical facility.

In general, in one aspect, the invention relates to a system for network communication. The system includes a remote access point and an enterprise network disposed in a first physical facility, a plurality of user devices coupled to the remote access point and disposed in the first physical facility, and a remote network disposed in a second physical facility separate from the first physical facility, wherein the remote access point is configured to have restricted access to the enterprise network, the restricted access providing a guest Internet service to the remote access point, wherein a secure communication tunnel is established, via the enterprise network and the Internet, to connect the remote access point and the remote network based on the restricted access, and wherein network communication data packets are transmitted, using the remote access point and through the secure communication tunnel, between the plurality of user devices disposed in the first physical facility and the remote network disposed in the second physical facility.

In general, in one aspect, the invention relates to a non-transitory computer readable medium (CRM) storing computer readable program code for network communication. The computer readable program code, when executed by a computer, includes functionality for configuring a remote access point to have restricted access to an enterprise network, wherein the remote access point and the enterprise network are disposed in a first physical facility, wherein the restricted access provides a guest Internet service to the remote access point, establishing, via the enterprise network and the Internet, a secure communication tunnel based on the restricted access to connect the remote access point and a remote network disposed in a second physical facility separate from the first physical facility, and transmitting, using the remote access point and through the secure communication tunnel, network communication data packets between a plurality of user devices disposed in the first physical facility and the remote network disposed in the second physical facility.

Other aspects and advantages will be apparent from the following description and the appended claims.

### BRIEF DESCRIPTION OF DRAWINGS

Specific embodiments of the disclosed technology will now be described in detail with reference to the accompanying figures. Like elements in the various figures are denoted by like reference numerals for consistency.

FIG. 1 shows a system in accordance with one or more embodiments.

FIG. 2 shows a flowchart in accordance with one or more embodiments.

FIG. 3 shows an example in accordance with one or more embodiments.

FIGS. 4A and 4B show a computing system in accordance with one or more embodiments.

### DETAILED DESCRIPTION

Specific embodiments of the disclosure will now be described in detail with reference to the accompanying figures. Like elements in the various figures are denoted by like reference numerals for consistency.

In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as using the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

Embodiments of the invention provide a method, a system, and a non-transitory computer readable medium for network communication. In one or more embodiments of the invention, a remote access point is configured to have restricted access to an enterprise network, where the remote access point and the enterprise network are disposed in a first physical facility, the restricted access providing a guest Internet service to the remote access point. Via the enterprise network and the Internet, a secure communication tunnel is established based on the restricted access to connect the remote access point and a remote network disposed in a second physical facility separate from the first physical facility. From the remote network via the secure communication tunnel, at least a portion of a guest local area network is configured, which is disposed in the first physical facility and segregate from the enterprise network. Multiple user devices connect to the remote access point via the guest local area network such that network communication data packets are transmitted between the user devices and the remote network using the remote access point and through the secure communication tunnel.

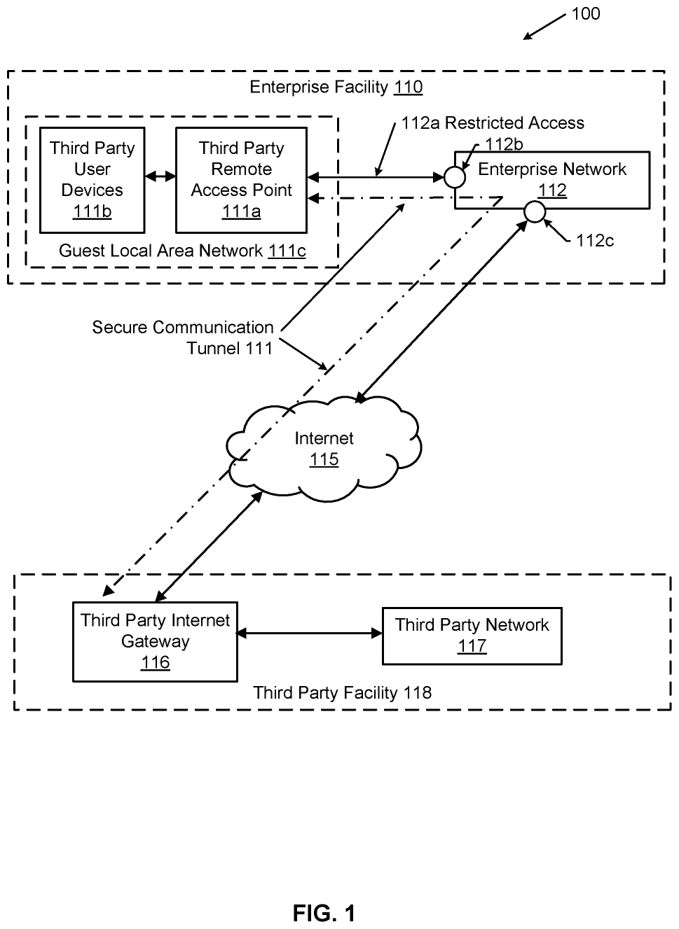

FIG. 1 shows a schematic diagram in accordance with one or more embodiments. In one or more embodiments, one or more of the modules and/or elements shown in FIG. 1 may be omitted, repeated, and/or substituted. Accordingly, embodiments of the invention should not be considered limited to the specific arrangements of modules and/or elements shown in FIG. 1.

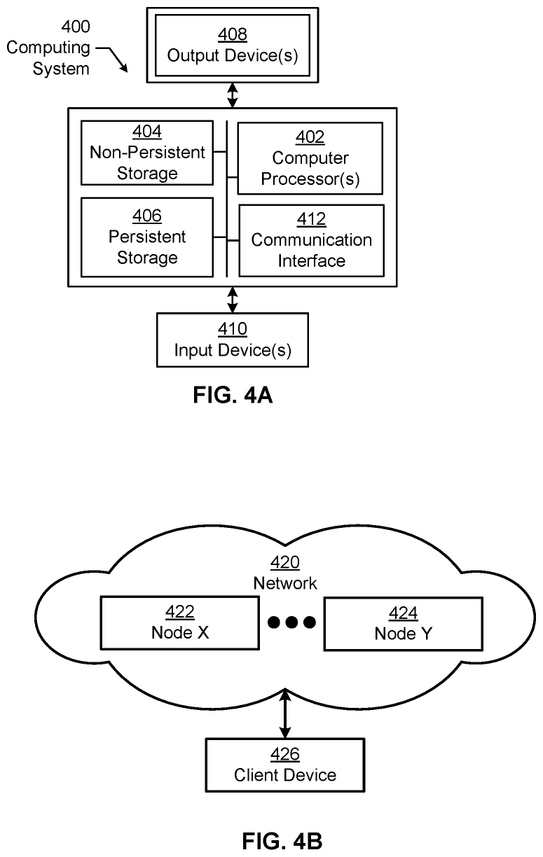

As shown in FIG. 1, the system (100) includes a third party remote access point (111a), third party devices (111b), an enterprise network (112), the Internet (115), a third party Internet gateway (116), and a third party network (117). In particular, the third party remote access point (111a), the third party devices (111b), and the enterprise network (112) are disposed in an enterprise facility (110), and the third party Internet gateway (116) and the third party network (117) are disposed in a third party facility (118) that is separate from the enterprise facility (110). In this context, the third party network (117) is also referred to as a remote network. For example, the enterprise network (112) and the enterprise facility (110) may be owned and operated by a company that engages contractors or other non-employee personnel (referred to as third parties) to work within the company's premise (i.e., the enterprise facility (110)). Similarly, the third party network (117) and the third party facility (118) may be owned and operated by a contractor service company that employs the contractors to provide services to the company or other customers of the contractor service company. Each of these components (111a, 111b, 112, 116, 117) may be implemented in hardware (i.e., circuitry), firmware, software, or any combination thereof. Further, these components (111a, 111b, 112, 116, 117) may be connected by wired and/or wireless communication paths. In one or more embodiments, these components may be implemented using the computing system (400) described below in reference to FIGS. 4A and 4B. Each of these components of FIG. 1 is discussed below.

In one or more embodiments of the invention, the third party the remote access point (111a) is configured to have restricted access (112a) to the enterprise network (112), where the restricted access (112a) provides a guest Internet service to the third party remote access point (111a). The restricted service (112a) prevents the third party remote access point (111a) and the third party user devices (111b) from accessing any resource of the enterprise network (112) except the guest Internet service. In one or more embodiments, the third party remote access point (111a) is configured as a guest client to an access point (112b) of the enterprise network (112), where the access point (112b) is a single point of connection between the third party remote access point (111a) and the enterprise network (112) to provide the restricted access (112a). In one or more embodiments, the third party remote access point (111a) and the access point (112b) are wireless access points that communicate wirelessly with each other.

In one or more embodiments of the invention, a secure communication tunnel (111) is established, via the enterprise network (112) and the Internet (115), to connect the third party remote access point (111a) and the third party network (117) based on the restricted access (112a). In one or more embodiments, a portion of the secure communication tunnel (111) is encapsulated within an existing network path of the enterprise network (112) and connects between the third party remote access point (111a) and an enterprise Internet gateway (112c) of the enterprise network (112). The secure communication tunnel (111) extends from the encapsulated portion through the Internet (115) to reach a third party Internet gateway (116) of the third party network (117). In one or more embodiments, the enterprise Internet gateway (112c) and the third party Internet gateway (116) are wireless Internet gateways.

In one or more embodiments of the invention, the third party user devices (111b) connect to the third party remote access point (111a) via a guest local area network (111c) disposed in the enterprise facility (110). the guest local area network is segregate from the enterprise network (112) and is configured and managed from the third party network (117) via the secure communication tunnel (111).

In one or more embodiments of the invention, network communication data packets are transmitted, using the third party remote access point (111a) and through the secure communication tunnel (111), between the third party user devices (111b) and the third party network (117).

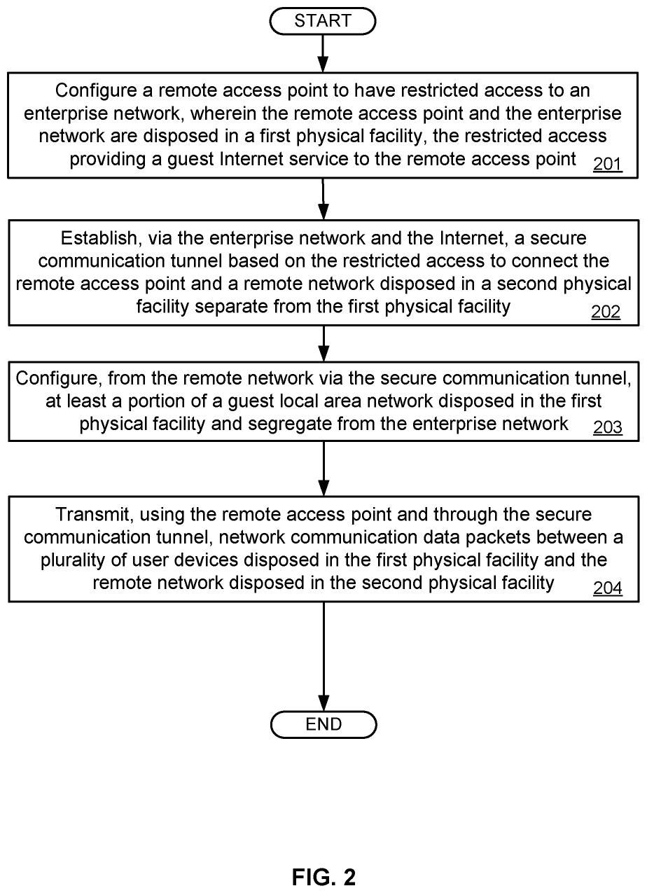

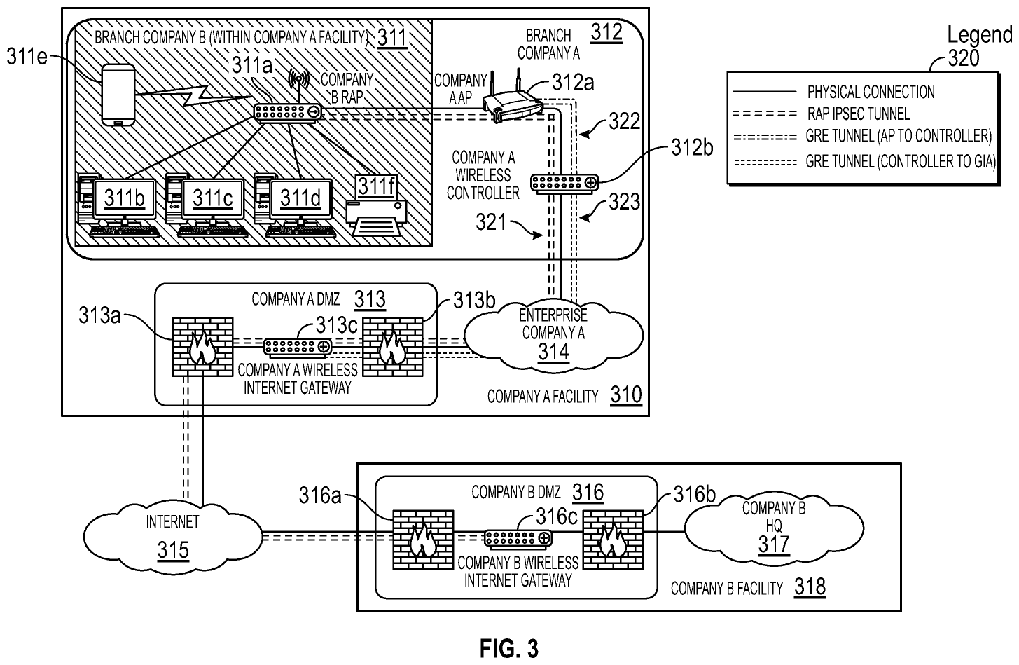

In one or more embodiments, the system (100) performs the functions described above using the method described in reference to FIG. 2 below. An example of the system (100) is described in reference to FIG. 3 below.

FIG. 2 shows a flowchart in accordance with one or more embodiments. One or more blocks in FIG. 2 may be performed using one or more components as described in FIG. 1. While the various blocks in FIG. 2 are presented and described sequentially, one of ordinary skill in the art will appreciate that some or all of the blocks may be executed in different orders, may be combined or omitted, and some or all of the blocks may be executed in parallel. Furthermore, the blocks may be performed actively or passively.

Initially in Block 201, a remote access point is configured to have restricted access to an enterprise network. In particular, the remote access point and the enterprise network are disposed in a first physical facility, and the restricted access provides a guest Internet service to the remote access point.

In Block 202, via the enterprise network and the Internet, a secure communication tunnel is established based on the restricted access to connect the remote access point and a remote network disposed in a second physical facility separate from the first physical facility.

In Block 203, from the remote network via the secure communication tunnel, at least a portion of a guest local area network is configured to connect multiple user devices to the remote access point. In particular, the guest local area network and the user devices are disposed in the first physical facility and segregate from the enterprise network.

In Block 204, using the remote access point and through the secure communication tunnel, network communication data packets are transmitted between the user devices disposed in the first physical facility and the remote network disposed in the second physical facility.

By way of the system and method of FIGS. 1 and 2, an application/process enhancement is envisioned for providing a third party remote access point within a company enterprise network to access a remote network of the third party located in a separate facility. The existing solution of providing dedicated/leased network connectivity for the third party within the company enterprise network is very costly, time consuming, and difficult to construct due to complicated installations over existing physical network. Alternative solutions using GSM/LTE services are not always available/reliable within buildings of the company facility.

FIG. 3 shows an example in accordance with one or more embodiments. The example shown in FIG. 3 is based on the system and method described in reference to FIGS. 1 and 2 above. The example shown in FIG. 3 relates to managing an enterprise network (314) of company A and associated components, in particular maintaining network securities with third parties/contractors working within the facility (310) of company A. The third parties/contractors are employed by company B and require connectivity to the enterprise network (317) of company B while working within the company A facility (310).

As shown in FIG. 3, the third parties/contractors use various devices within the company A facility (310), such as desktop computing devices (311b-311d), a printer device (311f), a mobile computing device (311e), etc. For example, the mobile computing device (311e) may be a notebook computer, a tablet, or a smart phone. The devices used by the third parties/contractors are connected to a remote access point (311a) thus forming a guest local area network, referred to as branch company B (311), within the company A facility (310) that is configured and managed by the company B.

Within the company A facility (310), the remote access point (311a) is configured as an ethernet guest client based on ethernet standard 802.3 or a wireless guest client based on wireless standard 802.11 that is uplinked to an enterprise guest access point (312a) of the company A enterprise network (314). For example, the enterprise guest access point (312a) may be a wireless access point that connects wirelessly to the remote access point (311a) and controlled by a wireless controller (312b) of the company A enterprise network (314). The remote access point (311a) and the wireless controller (312b) form a guest Internet service interface, referred to as branch company A (312). In another example, the enterprise guest access point (312a) may include an Ethernet port providing a wired connection to the remote access point (311a). Guest Internet service is a limited network service for a user to access Internet via the company A enterprise network (314) without being able to access any other resource of the company A enterprise network (314). Utilizing the guest Internet access of the company A enterprise network (314), the remote access point (311a) connects to the company B network (317) over the Internet (315) via a wireless Internet controller (313c) of the company A network (314) within the company A facility (310) and a wireless Internet controller (316c) of the company B network (317) within the company B facility (318). For example, the wireless Internet controller (313c) and associated firewall devices (313a, 313b) may be part of the company A DMZ (demilitarized zone) (313) for isolating the company A enterprise network (314) from the Internet (315). Similarly, the wireless Internet controller (316c) and associated firewall devices (316a, 316b) may be part of a company B DMZ (316) for isolating the company B network (317) from the Internet (315).

The remote access point (311a) may be authenticated via a guest account credential (e.g., username/password) provided by the company A or authenticated by configuring the Ethernet port of the enterprise guest access point (312a) with restricted rules to only communicate with the wireless Internet controller (316c) of the company B network (317). In particular, authenticating access requests from computing devices (311b-311f) via the remote access point (311a) by way of the guest account credential or the Ethernet port configuration prevents the computing devices (311b-311f) from accessing any other computing resources of the company A aside from the guest Internet service. Within the guest local area network (311), the remote access point (311a) may be provisioned to have Ethernet connections, Wi-Fi, or both for connecting to the devices (311b-311f). Additional network devices (e.g., firewall, switch, router, etc.) within the guest local area network (311) may also be connected to the remote access point (311a) and managed from the company B network (316).

To provide segregation between the guest local area network (311) and the company A enterprise network (314), data communications between the computing devices (311b-311f) and the company B network (317) are routed through an IPSec tunnel (321) encapsulated within Generic Routing Encapsulation (GRE) tunnels (322) and (323), as depicted in FIG. 3 according to the legend (320). IPSec stands for IP Security and is an Internet Engineering Task Force (IETF) standard suite of protocols between two communication points across the Internet Protocol (IP) network that provide data authentication, integrity, and confidentiality. Specifically, the GRE tunnel (322) routes data communication packets between the enterprise guest access point (312a) and the wireless controller (312b). The GRE tunnel (323) routes data communication packets between the enterprise guest access point (312a) and the wireless Internet controller (313c) (referred to as “GIA” in the legend (320)).

Embodiments may be implemented on a computing system. Any combination of mobile, desktop, server, router, switch, embedded device, or other types of hardware may be used. For example, as shown in FIG. 4A, the computing system (400) may include one or more computer processors (402), non-persistent storage (404) (e.g., volatile memory, such as random access memory (RAM), cache memory), persistent storage (406) (e.g., a hard disk, an optical drive such as a compact disk (CD) drive or digital versatile disk (DVD) drive, a flash memory, etc.), a communication interface (412) (e.g., Bluetooth interface, infrared interface, network interface, optical interface, etc.), and numerous other elements and functionalities.

The computer processor(s) (402) may be an integrated circuit for processing instructions. For example, the computer processor(s) may be one or more cores or micro-cores of a processor. The computing system (400) may also include one or more input devices (410), such as a touchscreen, keyboard, mouse, microphone, touchpad, electronic pen, or any other type of input device.

The communication interface (412) may include an integrated circuit for connecting the computing system (400) to a network (not shown) (e.g., a local area network (LAN), a wide area network (WAN) such as the Internet, mobile network, or any other type of network) and/or to another device, such as another computing device.

Further, the computing system (400) may include one or more output devices (408), such as a screen (e.g., a liquid crystal display (LCD), a plasma display, touchscreen, cathode ray tube (CRT) monitor, projector, or other display device), a printer, external storage, or any other output device. One or more of the output devices may be the same or different from the input device(s). The input and output device(s) may be locally or remotely connected to the computer processor(s) (402), non-persistent storage (404), and persistent storage (406). Many different types of computing systems exist, and the aforementioned input and output device(s) may take other forms.

Software instructions in the form of computer readable program code to perform embodiments of the disclosure may be stored, in whole or in part, temporarily or permanently, on a non-transitory computer readable medium such as a CD, DVD, storage device, a diskette, a tape, flash memory, physical memory, or any other computer readable storage medium. Specifically, the software instructions may correspond to computer readable program code that, when executed by a processor(s), is configured to perform one or more embodiments of the disclosure.

The computing system (400) in FIG. 4A may be connected to or be a part of a network. For example, as shown in FIG. 4B, the network (420) may include multiple nodes (e.g., node X (422), node Y (424)). Each node may correspond to a computing system, such as the computing system shown in FIG. 4A, or a group of nodes combined may correspond to the computing system shown in FIG. 4A. By way of an example, embodiments of the disclosure may be implemented on a node of a distributed system that is connected to other nodes. By way of another example, embodiments of the disclosure may be implemented on a distributed computing system having multiple nodes, where each portion of the disclosure may be located on a different node within the distributed computing system. Further, one or more elements of the aforementioned computing system (400) may be located at a remote location and connected to the other elements over a network.

Although not shown in FIG. 4B, the node may correspond to a blade in a server chassis that is connected to other nodes via a backplane. By way of another example, the node may correspond to a server in a data center. By way of another example, the node may correspond to a computer processor or micro-core of a computer processor with shared memory and/or resources.

The nodes (for example, node X (422), node Y (424)) in the network (420) may be configured to provide services for a client device (426). For example, the nodes may be part of a cloud computing system. The nodes may include functionality to receive requests from the client device (426) and transmit responses to the client device (426). The client device (426) may be a computing system, such as the computing system shown in FIG. 4A. Further, the client device (426) may include or perform all or a portion of one or more embodiments of the disclosure.

While the disclosure has been described with respect to a limited number of embodiments, those skilled in the art, having benefit of this disclosure, will appreciate that other embodiments can be devised which do not depart from the scope of the disclosure as disclosed herein. Accordingly, the scope of the disclosure should be limited only by the attached claims.

What is claimed is:

1. A method for network communication, comprising:
configuring a remote access point to have restricted access to an enterprise network, wherein the remote access point and the enterprise network are disposed in a first physical facility, the restricted access providing a guest Internet service to the remote access point;
establishing, via the enterprise network and the Internet, a secure communication tunnel based on the restricted access to connect the remote access point and a remote network disposed in a second physical facility separate from the first physical facility; and
transmitting, using the remote access point and through the secure communication tunnel, network communication data packets between a plurality of user devices disposed in the first physical facility and the remote network disposed in the second physical facility.

2. The method of claim 1, wherein the restricted service prevents the remote access point and the plurality of user devices from accessing any resource of the enterprise network except the guest Internet service.

3. The method of claim 1, wherein the remote access point is configured as a guest client to an access point of the enterprise network, wherein the access point is a single point of connection between the remote access point and the enterprise network to provide the restricted access.

4. The method of claim 3, wherein the remote access point and the access point are wireless access points that communicate wirelessly with each other.

5. The method of claim 4, wherein a portion of the secure communication tunnel is encapsulated within an existing network path of the enterprise network and connects between the remote access point and a first Internet gateway of the enterprise network, wherein the secure communication tunnel extends from the encapsulated portion through the Internet to reach a second Internet gateway of the remote network.

6. The method of claim 5, wherein the first Internet gateway and the second Internet gateway are wireless Internet gateways.

7. The method of claim 1, further comprising:
configuring, from the remote network via the secure communication tunnel, at least a portion of a guest local area network disposed in the first physical facility and segregate from the enterprise network,
wherein the plurality of user devices connect to the remote access point via the guest local area network.

8. A system for network communication, comprising:
a remote access point and an enterprise network disposed in a first physical facility;
a plurality of user devices coupled to the remote access point and disposed in the first physical facility; and
a remote network disposed in a second physical facility separate from the first physical facility,
wherein the remote access point is configured to have restricted access to the enterprise network, the restricted access providing a guest Internet service to the remote access point,
wherein a secure communication tunnel is established, via the enterprise network and the Internet, to connect the remote access point and the remote network based on the restricted access, and
wherein network communication data packets are transmitted, using the remote access point and through the secure communication tunnel, between the plurality of user devices disposed in the first physical facility and the remote network disposed in the second physical facility.

9. The system of claim 8, wherein the restricted service prevents the remote access point and the plurality of user devices from accessing any resource of the enterprise network except the guest Internet service.

10. The system of claim 8, wherein the remote access point is configured as a guest client to an access point of the enterprise network, wherein the access point is a single point of connection between the remote access point and the enterprise network to provide the restricted access.

11. The system of claim 10, wherein the remote access point and the access point are wireless access points that communicate wirelessly with each other.

12. The system of claim 11, wherein a portion of the secure communication tunnel is encapsulated within an existing network path of the enterprise network and connects between the remote access point and a first Internet gateway of the enterprise network, wherein the secure communication tunnel extends from the encapsulated portion through the Internet to reach a second Internet gateway of the remote network.

13. The system of claim 12, wherein the first Internet gateway and the second Internet gateway are wireless Internet gateways.

14. The system of claim 8, wherein the plurality of user devices connect to the remote access point via a guest local area network disposed in the first physical facility and segregate from the enterprise network, wherein the guest local area network is configured and managed from the remote network via the secure communication tunnel.

15. A non-transitory computer readable medium (CRM) storing computer readable program code for network communication, wherein the computer readable program code, when executed by a computer, comprises functionality for:
configuring a remote access point to have restricted access to an enterprise network, wherein the remote access point and the enterprise network are disposed in a first physical facility, wherein the restricted access provides a guest Internet service to the remote access point;
establishing, via the enterprise network and the Internet, a secure communication tunnel based on the restricted access to connect the remote access point and a remote network disposed in a second physical facility separate from the first physical facility; and
transmitting, using the remote access point and through the secure communication tunnel, network communication data packets between a plurality of user devices disposed in the first physical facility and the remote network disposed in the second physical facility.

16. The non-transitory CRM of claim 15, wherein the restricted service prevents the remote access point and the plurality of user devices from accessing any resource of the enterprise network except the guest Internet service.

17. The non-transitory CRM of claim 15, wherein the remote access point is configured as a guest client to an access point of the enterprise network, wherein the access point is a single point of connection between the remote access point and the enterprise network to provide the restricted access.

18. The non-transitory CRM of claim 17, wherein the remote access point and the access point are wireless access points that communicate wirelessly with each other.

19. The non-transitory CRM of claim 18, wherein a portion of the secure communication tunnel is encapsulated within an existing network path of the enterprise network and connects between the remote access point and a first Internet gateway of the enterprise network, wherein the secure communication tunnel extends from the encapsulated portion through the Internet to reach a second Internet gateway of the remote network, and wherein the first Internet gateway and the second Internet gateway are wireless Internet gateways.

20. The non-transitory CRM of claim 15, the computer readable program code, when executed by the computer, comprises functionality for:
configuring, from the remote network via the secure communication tunnel, at least a portion of a guest local area network disposed in the first physical facility and segregate from the enterprise network,
wherein the plurality of user devices connect to the remote access point via the guest local area network.
